(19) United States
(12) Patent Application Publication
(10) Pub. No.: US 2023/0189754 A1
(43) Pub. Date: Jun. 22, 2023

(54) Adjustable Slow Feed Pet Bowl

(71) Applicant: John J Stone, Golden, CO (US)

(72) Inventor: John J Stone, Golden, CO (US)

(21) Appl. No.: 17/559,743

(22) Filed: Dec. 22, 2021

(51) Int. Cl. A01K 5/01; F16M 11/32

(52) U.S. Cl. CPC A01K 5/0114; F16M 11/32

(57) ABSTRACT

The invention relates to a novel pet slow feeding dish with molded channels in the dish portion to receive kibble and which causes a pet to eat slowly and selectively, and the feeder is extendable to 3 heights by adjusting the legs.

### FIELD

The invention relates to a novel pet feeder that is adjustable to three heights and has a molded portion control dish portion.

### BACKGROUND OF THE INVENTION

The invention most closely corresponds with USPTO Class 119/51.01 wherein Class 119 relates to animal husbandry and sub-class 51.01 includes feeding devices.

In its simplest form, the invention relates to a novel pet feeder wherein hinged legs can be folded out in one configuration and be adjusted to two extended heights plus flat to a surface so that the feeder can adapt to a growing pet or to provide ergonomically comfortable feeding heights for varying size dogs.

The three feeder legs are a sturdy width and hinge then snap to a receiving section under the bowl. Anti-skid dots are on the bottom of the feeder so as not to allow the dish in its lowest position slide on a surface. Each leg is hollow to accept the second portion of leg to slide into that hollow portion and be locked in place to either of the two positions off the ground.

A unique feature of the dish is a molded bowl portion that creates groove and channels where kibble can be placed, and which the pet has to selectively pick its way through the maze of grooves to select and eat kibble.

### THE INVENTION

### Summary, Objects and Advantages

It is fairly well known that overweight dogs can experience a myriad of medical problems, which could be avoided by maintaining a healthy weight. These health problems can drastically shorten a dog's life. Weight related illnesses include diabetes, heart disease, arthritis and the list goes on.

It is also known that most dogs do not observe a limit at mealtimes and especially puppies will eat far past the full stage. Thus pet owners have to monitor or measure food, or purchase some feeding device that hopefully controls portions. Not all such feeding devices work well or are practical in all situations.

The inventive feeder is an easy to use method of not only controlling portions, but it is a feeder that can grow with a dog from the puppy stage to the adult stage. The pet owner does not have to purchase different food dishes as the pet grows.

Older dogs often have trouble with their joints and having to extend far over to reach a food bowl sitting on the floor can be painful for them. Conversely, a small dog is not able to reach a feeder that is already extending up from the floor. The inventive feeder easily adjusts for all these eventualities.

There are extendable pet feeders in the art that comprise rod-like legs and a ring wherein a dish may be placed. These feeders are not sturdy or stable. The inventive feeder has extendable hinged legs that are more than an inch wide and are approximately a half inch thick. This feeder will not wobble or topple as most aforementioned feeders will.

A 3-leg tripod configuration is used for optimum stability at any height. The wide legs snap into the bowl base and then are hinged so that the leg can be folded inward and snap into the base piece. At the base of each leg is a rubber skid resistant pad material to add stability to the bowl and aid in preventing the bowl from sliding.

With the legs in the first position the feeder is approximately six (6) and one-half inches from a surface. Depressing the button on the outside of a leg releases a second leg portion from within that extends out to then create a ten (10) inch high feeder.

A further novel feature is the portion control molded bowl section of the feeder. The molded grooves allow for kibble to be spread around the feeder and require the dog to slow down its consumption. The assembly is a single piece since the legs fold and extend but are not removeable. This makes the bowl easy to travel with as well.

### BRIEF DESCRIPTION OF THE DRAWINGS

The invention is described in further detail by reference to six (6) drawings sufficient in detail to describe the invention in which:

FIG. 1 is a top-down view of the feeder in flat or “home” position;

FIG. 2 is a side perspective of the feeder in home position;

FIG. 3 shows the underside of the feeder with all 3 legs snapped into the dish base;

FIG. 4 is a side perspective of the feeder dish in “first position”, meaning the legs are extended into a first position and snapped into place;

FIG. 5 is a side perspective of the feeder dish in “second position”, meaning the legs are extended into a second and final position and snapped into place; and

FIG. 6 is a side perspective illustrating the slow-feed dish and the leg buttons.

### DETAILED DESCRIPTION, INCLUDING BEST MODES OF CARRYING OUT THE INVENTION

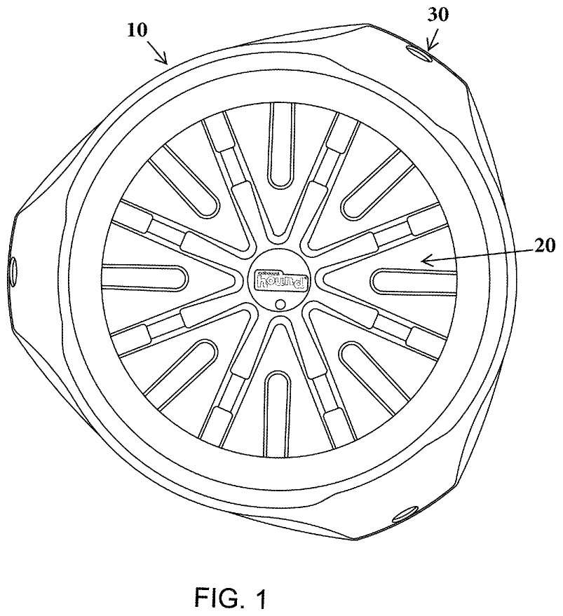

FIG. 1 shows the feeder dish base 10, without extended legs. The molded portion of the slow feed dish 20 contains multiple channels where kibble will rest when the pet owner places kibble within the dish. The buttons for releasing the legs is also shown 30. A user simply presses the button to release two sections of extendable leg.

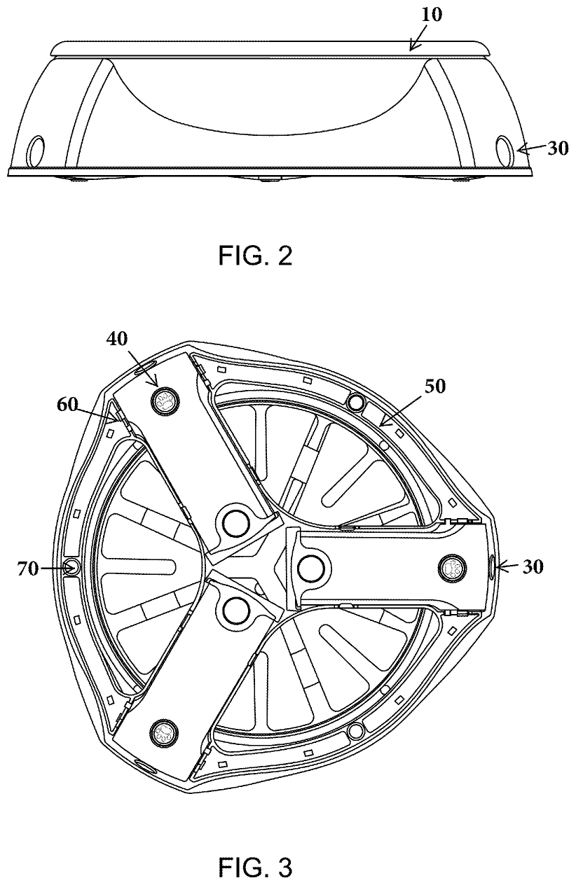

FIG. 2 shows a side perspective of the feeder dish 10 and the buttons 30 that are depressible to extend the legs of the bowl. with the legs 40 into the home position wherein each leg snaps into a receiving portion 50 molded to the bottom of the bowl to snap-fit the legs within.

FIG. 3 shows the underside of the feeder 20 with the legs 40 into the home position wherein each leg snaps into a receiving portion 50 molded to the bottom of the bowl to snap-fit the legs within. Each leg is hinged at its bending point 70. This height is suitable for small dogs. Anti-skid dots 60 contact the surface when the feeder dish is this position so the it will not slide on a smooth surface.

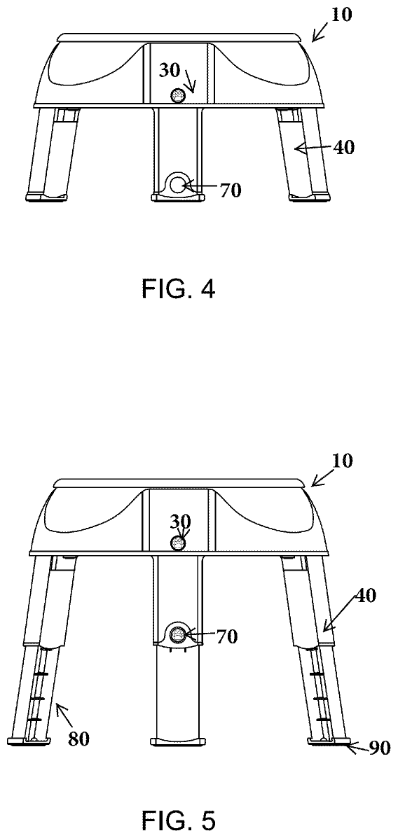

FIG. 4 is a side perspective of the feeder dish 10 with the three legs in first position. The button that was pressed to attain this position are also shown 30. The second button on the leg 70 will allow the leg portion within that hollow first portion of leg to be extended to a second and final position.

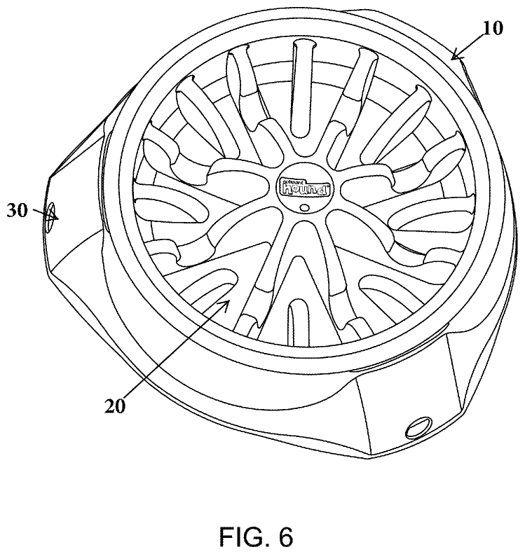

FIG. 5 is a side perspective of the feeder dish 10 with the three legs 40 extended to a second and final position. The inner portion of the legs 80 shows the hollow section where each extension of leg resides when not extended. Again the button for use in extending the legs 30 is shown, and well as the second position button 70. The base of the legs 90 contain anti-slip rubber on the “feet” portions to keep the dish from sliding along smooth surfaces. This position is ideal for large dogs.

FIG. 6 is a top-down angle showing the dish 10 and the series of channels 20 that have been molded into the bow for slowing the feed rate of the pet. Again, the buttons 30 for extending the legs into first position are shown.

1. An adjustable slow feed pet bowl comprising:
a) a single piece molded dish portion
b) only three extendable legs
c) two buttons per leg for releasing the legs
d) anti-skid dots on the bowl and the legs
e) a receiving section for the legs in the base piece

2. The adjustable slow feed pet bowl as in claim 1 wherein the molded dish portion contains channels molded as part of the entire bowl wherein pet kibble is placed and falls into the channels so the pet must eat selectively and slowly to get the kibble from the channels.

3. The adjustable slow feed pet bowl as in claim 1 wherein only three legs are attached by hinges to the dish portion and wherein the first portion of the leg is hollow so that the second portion of the leg may be extended out from the hollow portion of each leg.

4. The adjustable slow feed pet bowl as in claim 1 wherein a button on the bowl portion near each leg is pressed to release the legs into a first position and be locked when the leg clicks into the button opening.

5. The adjustable slow feed pet bowl as in claim 1 wherein a button is located on each leg to be pressed to allow the second portion of leg to extend out from within the hollow first leg section and release the legs into the second and final highest position.

6. The adjustable slow feed pet bowl as in claim 1 wherein anti-skid dots are located on the bottom of the bowl when it is in home position with no leg extension.

7. The adjustable slow feed pet bowl as in claim 1 wherein each of the three legs has anti-skid rubber on the bottom so that when the legs are extended in either of the first or second positions, it will not slide easily on smooth surfaces.
